(19) United States
(12) Patent Application Publication
(10) Pub. No.: US 2004/0210546 A1
(43) Pub. Date: Oct. 21, 2004

(54) System and method for spatial organization

(76) Inventors: Christopher Spooner, Bethesda, MD (US); Richard Spooner, Bethesda, MD (US)

Correspondence Address: GREENBERG-TRAURIG, 1750 TYSONS BOULEVARD, 12TH FLOOR, MCLEAN, VA, 22102, US

(21) Appl. No.: 10/755,853

(22) Filed: Jan. 13, 2004

Related U.S. Application Data
(60) Provisional application No. 60/439,446, filed on Jan. 13, 2003.

(51) Int. Cl. G06F 17/00; G06N 5/00; G06F 17/30; G06F 7/00

(52) U.S. Cl. 706/45; 707/3

(57) ABSTRACT

A method for determining the spatial location of an object within a containing space, comprising iteratively sub-dividing the containing space into parent and child spaces and evaluating whether the object is completely contained within the space. An alternative method comprises iteratively sub-dividing the containing space until the object in question completely

### PRIORITY CLAIM

This application claims priority from Provisional U.S. Patent Application Serial 60/439,446, and U.S. patent applications Ser. No. 09/946,938, filed Sep. 06, 2001, and Ser. No. 09/853,821 filed May 14, 2001, which is a continuation of U.S. patent application Ser. No. 09/064,824, filed Apr. 23, 1998 now U.S. Pat. No. 6,256,618, which are hereby incorporated by reference in their entirety.

### COPYRIGHT NOTICE

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of operating systems, and, more particularly, to a unique spatial organization to be used by or in operating systems.

### BACKGROUND OF THE INVENTION

Conventional operating systems provide application interface software that enables applications to share the same basic 2-dimensional “look-and-feel”. But 3-dimensional modeling is left to the individual applications, and, while modern operating systems provide basic modeling utilities, they provide no cohesive architecture into which applications can fit their 3-D modeling. The result is that conventional operating systems provide no means for providing dynamic and spontaneous interoperability between applications, at the graphical level. Two independent applications may have their own modeling architectures, but, because they are not defined by the operating system, the models cannot merge. For example, two independent software designers create a flight simulator and a virtual exploratory atlas, respectively. Conventionally, these would be separate applications. Conventionally, a user can merge the two only if the two software designers worked together.

Another issue is that of navigation. People have an innate ability to navigate, find things, recognize things, and operate within a three-dimensional environment. For example, people don't memorize street names or maps in order to familiarize themselves with a new city; instead, as they explore, they gradually put together a mental image of the city. They don't memorize lengths of streets; rather, they have a more primitive understanding of relative positions.

Navigating the conventional operating systems is like the memorization approach. There are hierarchies of folders and file names, coupled with a relatively tiny set of icons that do little to aid the memory and, sometimes, a difficult-to-use command language. For example, a user is looking for a particular file. They have to ask themselves questions such as “what was its name?”, or “what folder did I leave it in?”

As conventional systems grow, people lose their familiarity with the contents. Entire folders, and folders of folders, become alien, as people forget what they were, and what they contain. People do not naturally think in terms of hierarchies of folders, since it would be like trying to familiarize oneself with a town strictly by memorizing names.

These problems become particularly acute when application-level content and information, written by different people, without any coordination, and using diverse programming and graphical tools, is strewn over a constantly changing, non-centrally designed network like the Internet.

### SUMMARY OF THE INVENTION

Therefore, what is needed is a system and method for spatial organization (encompassing viewing, display, movement, security, communication, information access, resource access) which can be used across large scale grid computing systems, Internet-based sub-networks, and distributed computing environments, by different computer languages and applications, and by users with different languages and styles. The system will incorporate unique dataflow and kernel meshing technologies to allow broad application.

One aspect of the invention is a method of determining the spatial location of an object in question within a containing space, comprising defining a containing space; identifying an object in question within the containing space; dividing the containing space into a plurality of parent spaces; and, for each of the parent spaces, iteratively repeating a query process, comprising: querying the parent space to determine if the object in question is within the parent space; if the object in question is completely within or completely outside the parent space, returning the result to the containing space; and if the object in question is partially within the parent space, subdividing the parent space into a plurality of child spaces, and iteratively repeating the query process for each of the child spaces, wherein each child space is treated as a parent space.

Another aspect of the invention includes a method of determining the spatial location of an object in question within a containing space, comprising defining a containing space; identifying an object in question within the containing space; dividing the containing space into a plurality of parent spaces; and, for each of the parent spaces, iteratively repeating a query process, comprising: querying the parent space to determine if the parent space is within the object question; if the parent space is completely within or completely outside the object in question, returning the result to the containing space; and if the parent space is partially within the object in question, subdividing the parent space into a plurality of child spaces, and iteratively repeating the query process for each of the child spaces, wherein each child space is treated as a parent space.

Still another aspect of the invention includes a method of determining the spatial location of an object in question within a containing space, comprising defining a containing space; identifying an object in question within the containing space; dividing the containing space into a plurality of parent spaces; for each of the parent spaces, iteratively repeating a query process, comprising: querying the object in question to determine if the parent space is within the object question; if the parent space is completely within or completely outside the object in question, returning the result to the containing space; and if the parent space is partially within the object in question, subdividing the parent space into a plurality of child spaces, and iteratively repeating the query process for each of the child spaces, wherein each child space is treated as a parent space.

Accordingly, the present invention is directed to a system and method for spatial organization that substantially obviates one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a depiction of a two dimensional view of the spatial organization concept of the present invention.

FIG. 2 is a two dimensional depiction of one aspect of the spatial organization concept of the present invention.

FIG. 3 is a two dimensional view of the spatial organization concept of the present invention.

FIG. 4 is a depiction of the integration of the operating system language framework, and development environment.

FIG. 5 is a block diagram of the deep connections concept of the present invention.

FIG. 6 is a schematic diagram of the benefits of the present invention for the developer.

FIG. 7 is a depiction of the benefits of the present invention to the individual user.

FIG. 8 is a schematic diagram of the interplay of the various components of the present invention.

FIG. 9 is a block diagram of the kernel merging between the kernel of the present invention and various kernels of various computer language and software applications.

FIG. 10 is a depiction of another aspect of the present invention.

FIG. 11 is a schematic diagram of the object oriented and language oriented aspects of the present invention.

FIG. 12 is a depiction of the language overlay capabilities of the present invention.

FIG. 13 is another depiction of the language overlay of the present invention.

FIG. 14 is a schematic diagram of further aspects of the present invention.

FIG. 15 is a depiction of the user's ability to communicate in any verbal or computing language using the present invention.

FIG. 16 is a depiction of the present invention incorporated into a grid computer structure.

FIG. 17 is a depiction of the present invention incorporated in grid computer structure and the user interaction.

FIG. 18 provides a schematic view of language oriented aspects of the present invention.

FIG. 19 highlights certain features of language oriented aspect of the present invention.

FIG. 20 provides a three dimensional image of various aspects pertinent to the spatial organization aspects of the present invention.

### DETAILED DESCRIPTION OF THE PREFERRED EMBODIMENT

Reference will now be made in detail to the preferred embodiments of the present invention, examples of which are illustrated in the accompanying drawings.

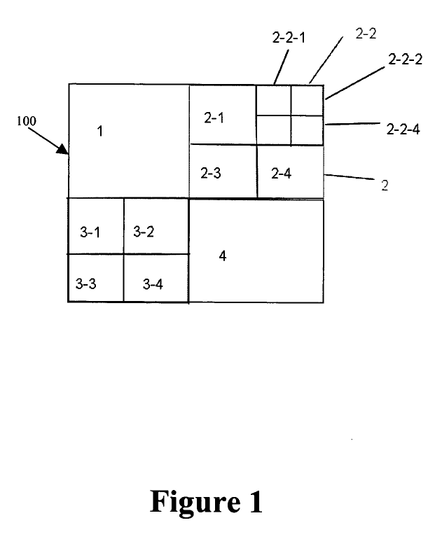

FIG. 1 illustrates a preferred spatial organization technique. FIG. 1 applies the spatial organization technique to a two-dimensional structure, illustrated in FIG. 1 as square 100. Although a square is used for illustrative purposes, it should be apparent to one skilled in the art that the organization technique is not dependent on the shape of the structure, and is therefore not limited to such structures.

As FIG. 1 illustrates, square 100 can be divided into a plurality of smaller, child squares. In FIG. 1, square 100 (also referred to as a parent square) was broken down into four child squares, labeled as child squares 1, 2, 3, and 4. Each of these child squares can be treated as parent squares, and similarly divided into a plurality of child squares. This is illustrated in FIG. 1 by breaking square 3 into four components, 3-1, 3-2, 3-3, and 3-4. This process can be iteratively repeated, as is illustrated by the sub-division of square 2-2 into child squares 2-2-1, 2-2-2, 2-2-3, and 2-2-4, and may continue to be repeated until the lowest level of information granularity is reached, or until a desired outcome occurs.

In a preferred embodiment, each subdivision iteration divides the parent square into the same number of child squares. Each square, at any level of depth, can be identified by a series of numbers between 1 and the number of squares into which the parent was divided. By way of example, without intending to limit the present invention, since each subdivision iteration in the embodiment illustrated in FIG. 1 divided each parent square into four child squares, the upper right-hand most square in FIG. 1 can be identified as square 2-2-2, and the square just below it can be identified as square 2-2-4.

A similar spatial organizational technique can be applied to structures of more than two dimensions. By way of example, without intending to limit the present invention, in a three dimensional space, a parent cube can be divided into a plurality of child cubes, with each cube identified by a series of numbers between 1 and the number of cubes into which the parent was divided. For example, a traditional cube may be easily divided into eight, similarly sized child cubes.

The spatial organization technique can also be applied to one dimensional structures. An illustrative example of the use of the spatial organization technique is for organizing distance and time measurements. In addition, other applications of one dimensional equivalents may be for such things as fuzziness, volume or any other quantifiable concept.

This framework provides the basic mechanism through which spatial areas can be readily identified. Essentially, the system creates a unique coordinate system with a plethora of applications.

As FIG. 1 illustrates, every object, except square 100, also referred to as the “root”, and the undivided squares (e.g. squares 1, 2-2-1, 2-2-2, 2-2-3, and 2-2-4), also referred to as the “leaves”, servers as both a child of another object and a parent to one or more objects. These two roles are separate. A child object corresponds to a “thing” and a parent object corresponds to a “place.” By way of illustration, an airplane is a thing to the outside world, but a place to the passengers. As a thing, the airplane object maintains a one-to-one relationship with the outside world, such as the sky, but as a place it maintains a one-to-many relationship with the things inside (passengers, luggage, equipment, and the like).

Each object can contain one or more pieces of information. When an object serves as a parent object, the parent object preferably maintains separate squares, cubes or other spaces for its children, in addition to storing parent object specific information.

FIG. 1 illustrates child spaces which are completely contained within a parent space. However, it should be apparent to one skilled in the art that the space associated with a child object need not be aligned to its parent's space, nor strictly confined within the parent's space.

Within this hierarchy, the parent object forms a space in which a child object can reside. The role of the child objects is to answer questions such as “are you in square 2-2-1?” or “what color are you, square 3-4?” for example. A key point is that, as a convention, the answers may be ambiguous; that is, the child may not be able to answer with the precision required by the parent. If a questioner wants more detail, the questioner can simply have the child divide itself into a plurality of objects, and can question each of these objects in turn. The questioner thus controls the level of detail and therefore, the use of bandwidth and CPU time.

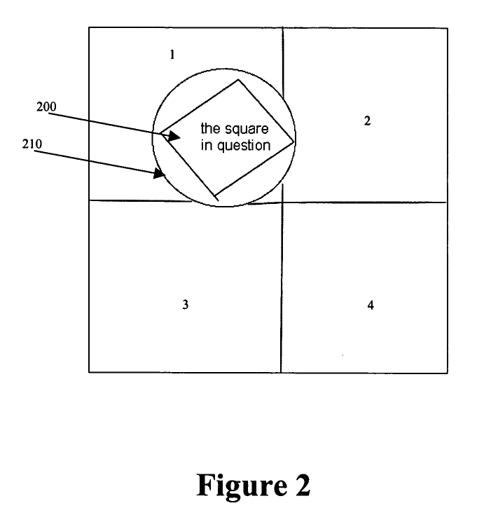

As illustrated the two dimensional illustration of FIG. 2, child spaces need not, as a rule, use any kind of trigonometry to construct their answer. Instead, they find the largest space in their own overall space (i.e. their own “spatial context”) that fully encompasses a circle around space in question 200, where space in question 200 falls within the parent's spatial context. Circles are preferable, as they can be easily transferred from one spatial context into a different, non-aligned, spatial context. Such operations are rendered through relatively simple calculations. In the event space in question 200 is not completely contained within the child object, the child object can indicate this to the parent space. By way of example, without intending to limit the present invention, in FIG. 2, if square 200 asked square 4 whether square 4 is contained within space in question 200, square 4 would answer “no”. Similarly, if square 4 were asked if space in question 200 is contained within square 4, square 4 would answer “no”. By contrast, squares 1 and 2 could answer “yes, but not completely” if asked if space in question 200 is contained in each respective square.

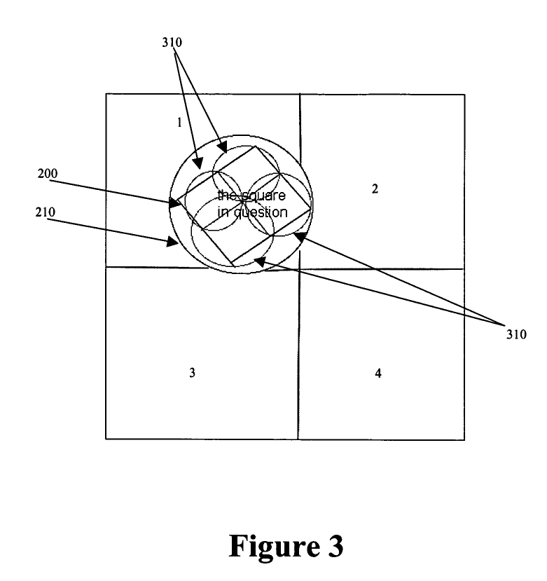

As illustrated in FIG. 3, space in question 200 can be similarly subdivided into a plurality of child spaces s1, s2, s3, and s4, and each of these child spaces can be requeried regarding the circles around each space, and each space within square 100 can be queried with respect to each of the child spaces. By way of example, without intending to limit the present invention, square 1 can answer that child spaces s1, s2, and s3 are within square 1. Square 1 can answer that child space s4 is contained within space 1, but not completely. In this way, the system can quickly determine which child spaces should be further sub-divided for additional queries. Notice that as the parent's square keeps getting sub-divided, the child is more likely to be able to provide a concrete answer, such as “I am not in that square” or “I fully occupy that square”, as opposed to the more generic “I occupy some of that square, but I don't know how much of it.”

By way of example, without intending to limit the present invention, in a three dimensional (3D) environment, a parent may be concerned about sub-cube 1-4-7-3. A child object in question cannot easily (without trigonometry) answer whether it fully occupies this cube, so the child object in question may answer a different question, whether it fully occupies a sphere enclosing sub-cube 1-4-7-3. The child knows that if this answer is “fully”, then any sub-division would also answer “fully”; if the answer is “not at all”, any sub-divisions would also answer “not at all”; and if the answer is “partial”, then any sub-division thereof could answer “partial”, “not at all”, or “fully”. The child does so knowing that the parent can always further refine the question into sub-cubes 1-4-7-3-1 to 1-4-7-3-8, if an ambiguous answer is insufficient. The child takes this sphere and puts it into it's own spatial context. Through simple calculations, it calculates the smallest cube (for example, 3-5-2) which fully encompasses that sphere. Ultimately, it answers the question about C 3-5-2, knowing that a “full” or “empty” answer is accurate for both C 3-5-2, as well as the original P 1-4-7-3.

Further, children may use this same basic mechanism to query their own children and pass the answer on to the questioner. This is useful for situations where parent, children, and grandchildren objects (and so on), may all be located on different physical machines. It may be impractical for all spatial information to be held on one machine (without great sacrifices in mobility).

Viewing, graphical or image applications use the same mechanism or spatial organization but instead of asking whether or not an object resides in a square or cube, it would ask for colors or other information.

As an alternative, conically-shaped viewers can be created by creating a new spatial context out of concentric spheres and cones, as opposed to cubes. This spatial context begins as two concentric spheres (enclosing a “layer”), and a single cone. Two new layers can be created by inserting a new sphere between the two old enclosing spheres. Cones are subdivided into four sub-cones, by placing four slightly overlapping cones within the original cone. The result is a hierarchy similar to the cube hierarchy, but which sub-divides space according to a vantage point. This hierarchy expresses a two-dimensional (2D) view of 3D space, and can be an alternative to conventional pixel maps.

The conically-shaped viewer is then positioned within a conventional cube-shaped spatial context, and through the drill-down questioning, the viewer can map out an area of 3D space for the purpose of viewing or any other type of information (sound, heat, gravity, and so on). Alternatively, the viewer can be used to project information, and organize the absorption of information. By way of example, without intending to limit the present invention, one application of the present invention is the creation of a virtual light, which would use the viewer to project the light, and other objects would alter this projection to reflect, refract, absorb, or otherwise interact with the light. The changes would be expressed within the viewer, and therefore the virtual light would have depth-sensitive information readily available for recasting the light whenever objects move. Thus, calculation of shadows can be implemented on the same “incremental” basis that position and collision detection use.

There is no limit to the use of the present invention since objects can use the underlying language framework to create any other kinds of questions or convey other types of information. Since the organizational mechanism is shared by all objects, they can refer to it freely with conventional questions or statements For example, one object could ask another object (designed by a different developer, and located on a different machine), to provide a conically-shaped blueprint of the types of material in the second object; since both objects agree on the meaning of “conically-shaped”, the spatial elements of both the question and the answer will be understood.

The basic mechanisms used by ordinary objects, as well as lights and viewers, lend themselves naturally to parallelism (either through hardware or through connected machines), since the drill-down mechanisms provide natural branching points. Therefore, in addition to providing a natural framework for organizing graphical content across machines (where developers do not coordinate their efforts), this architecture provides a natural framework for implementing graphics within a parallel or clustered environment.

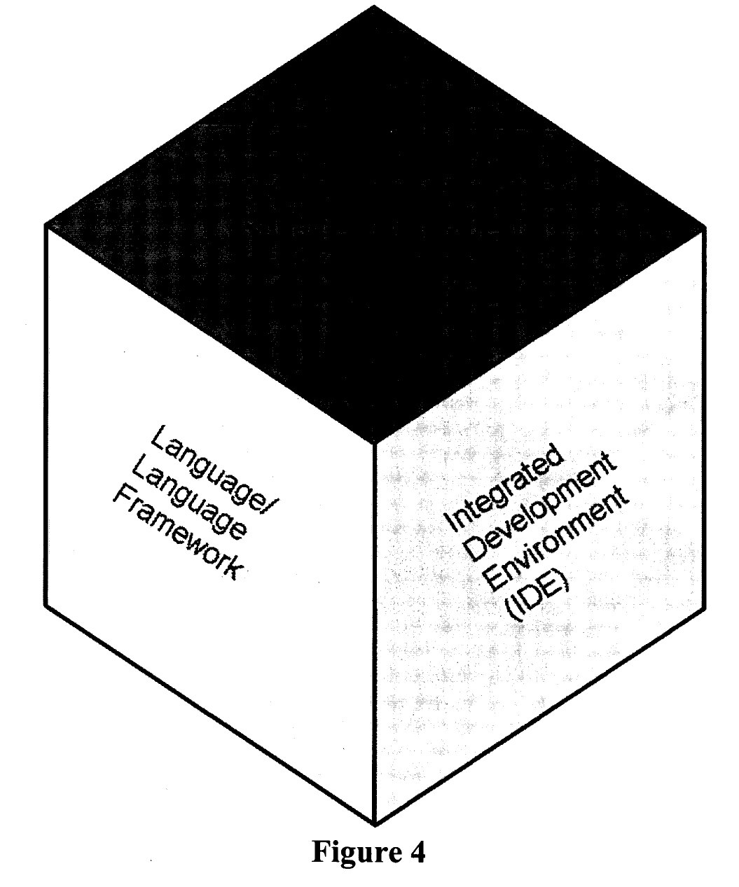

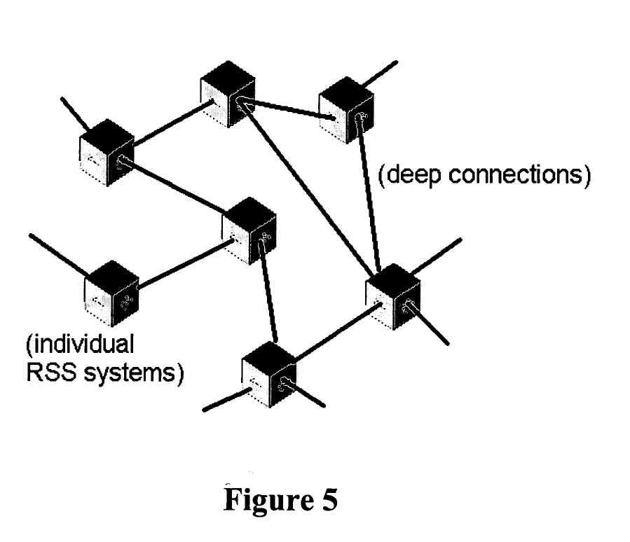

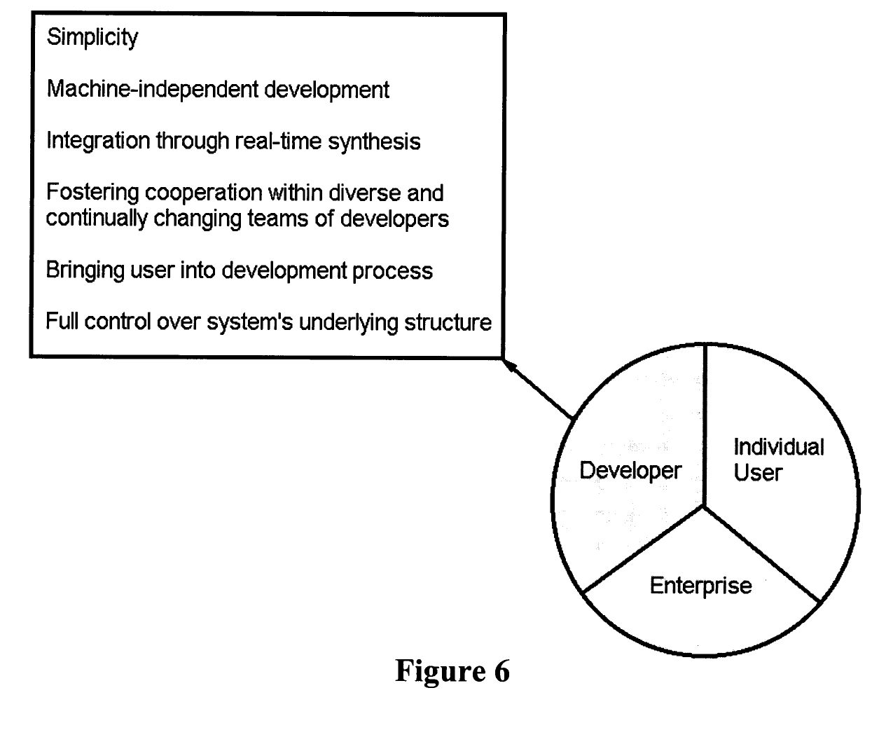

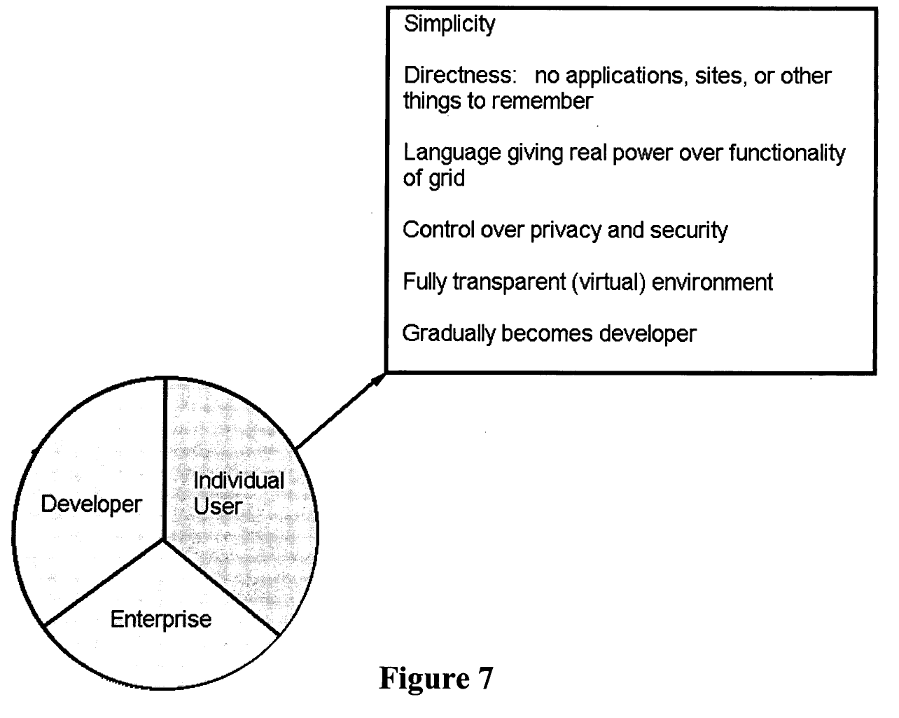

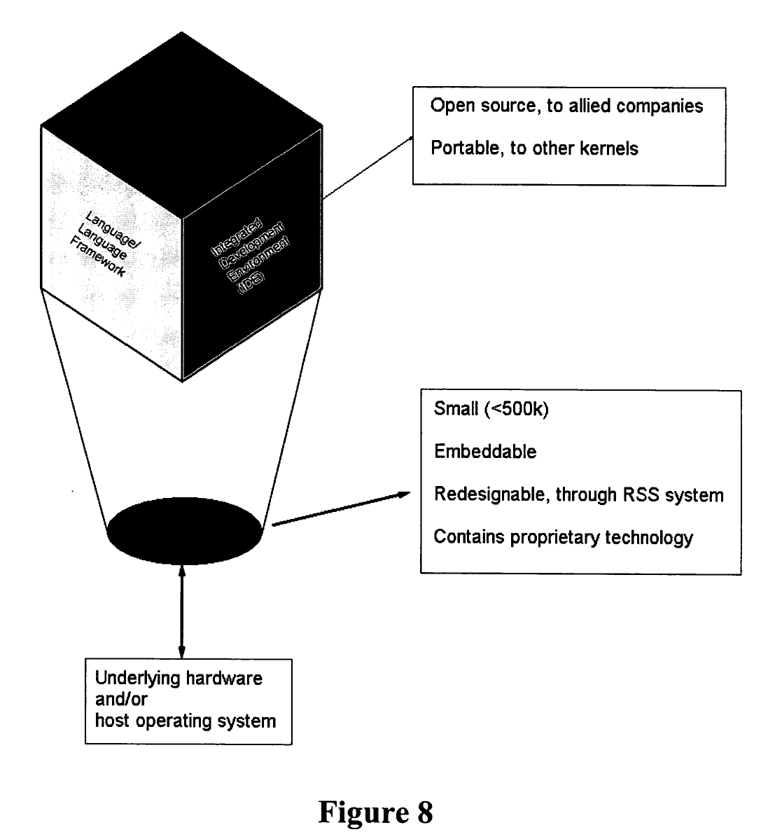

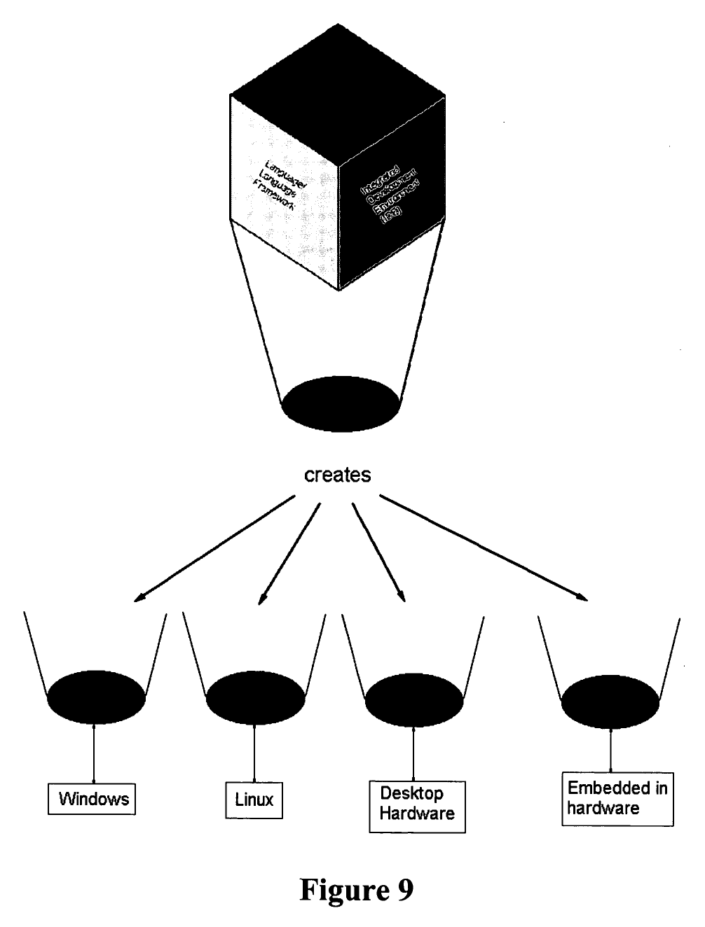

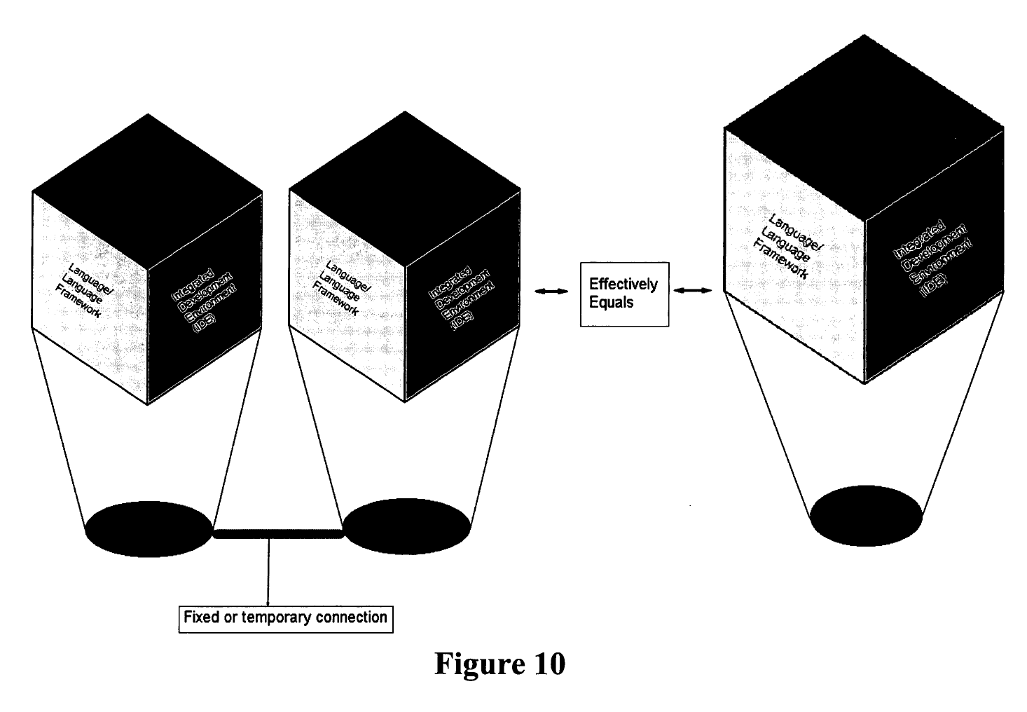

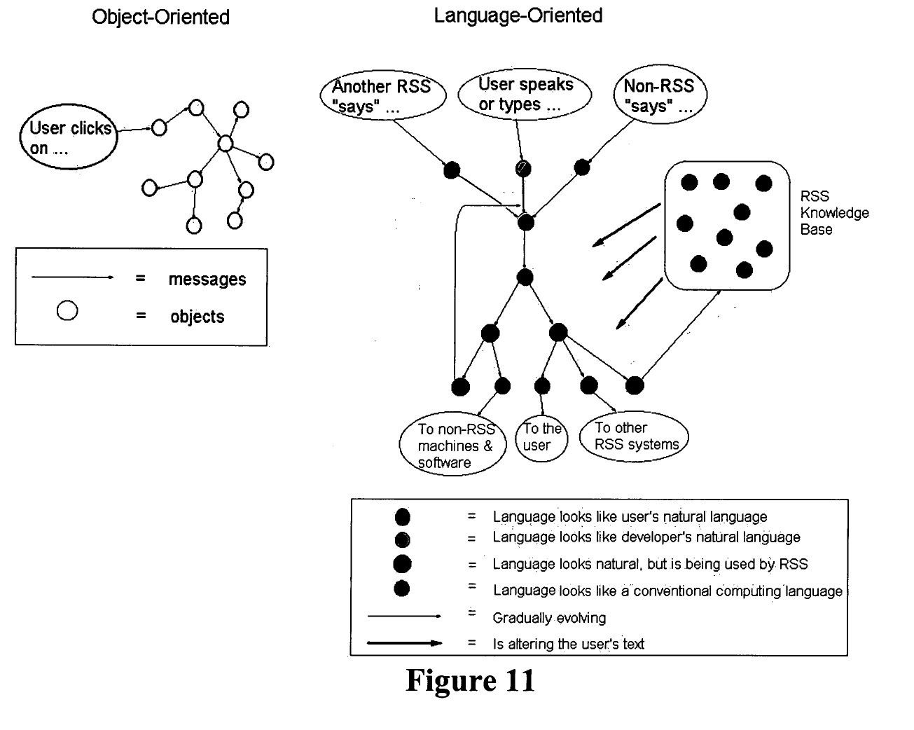

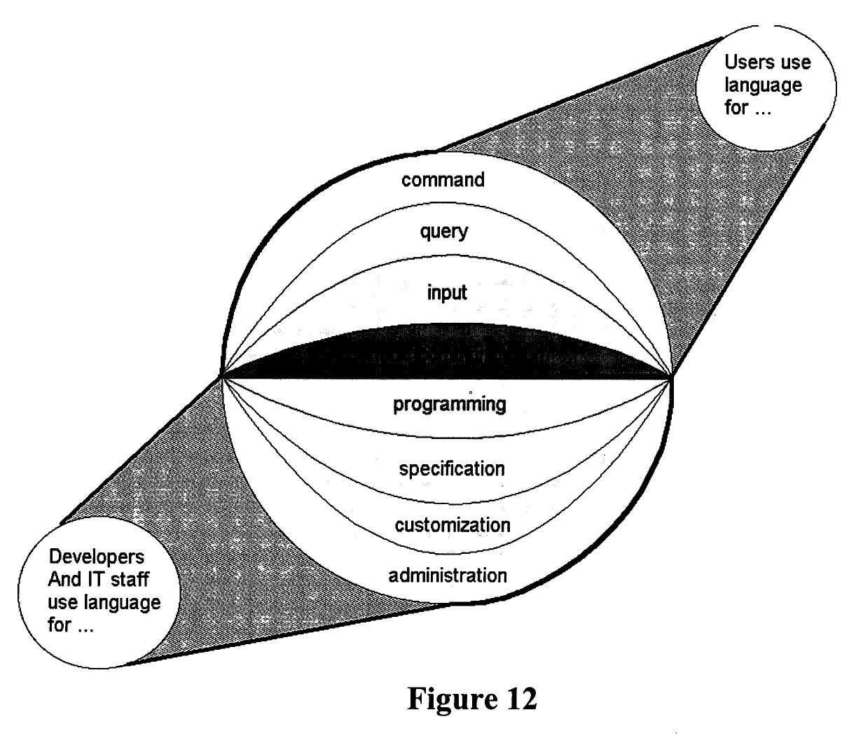

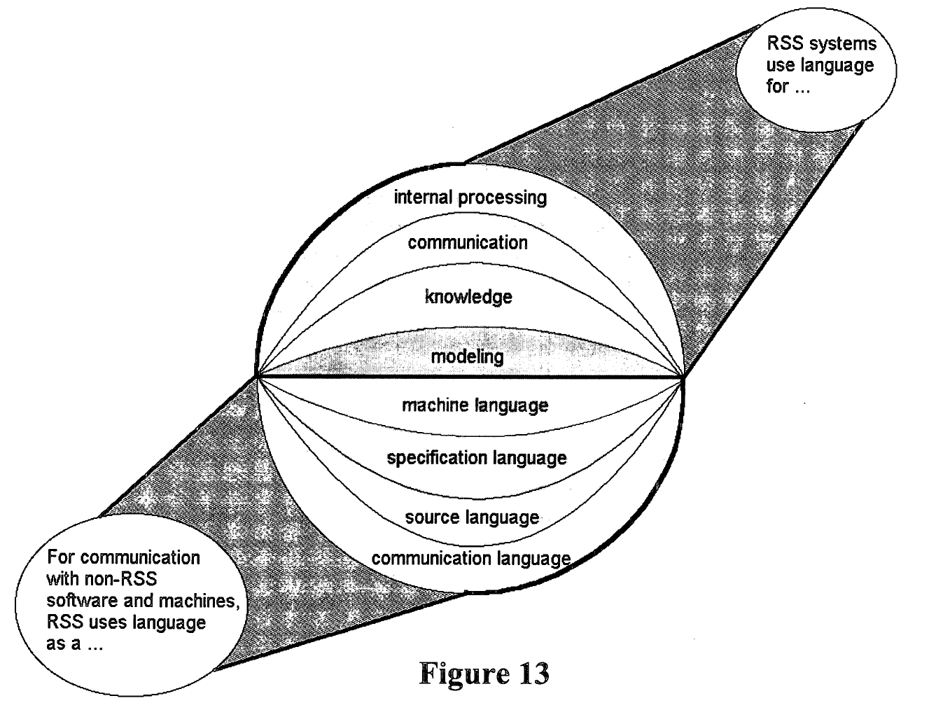

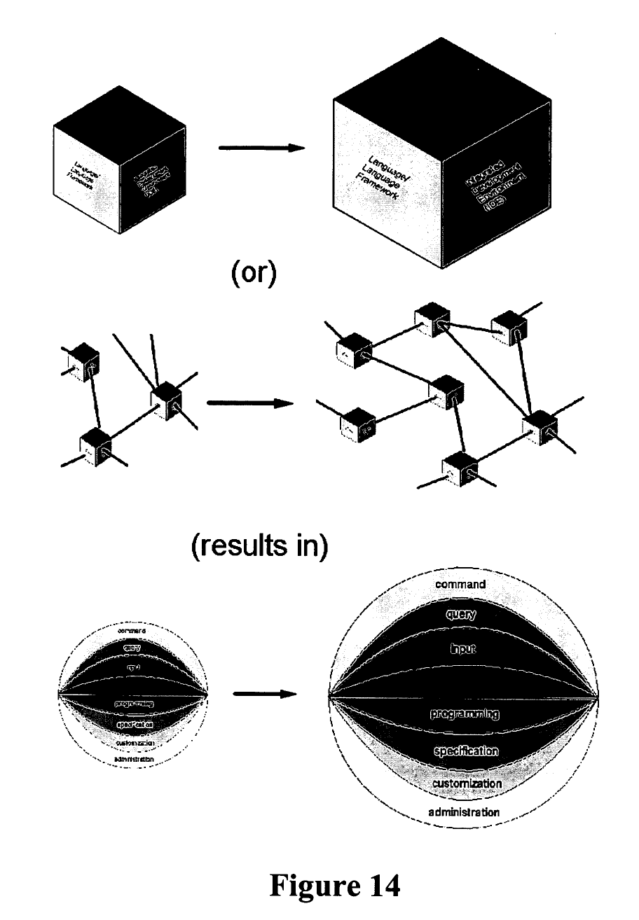

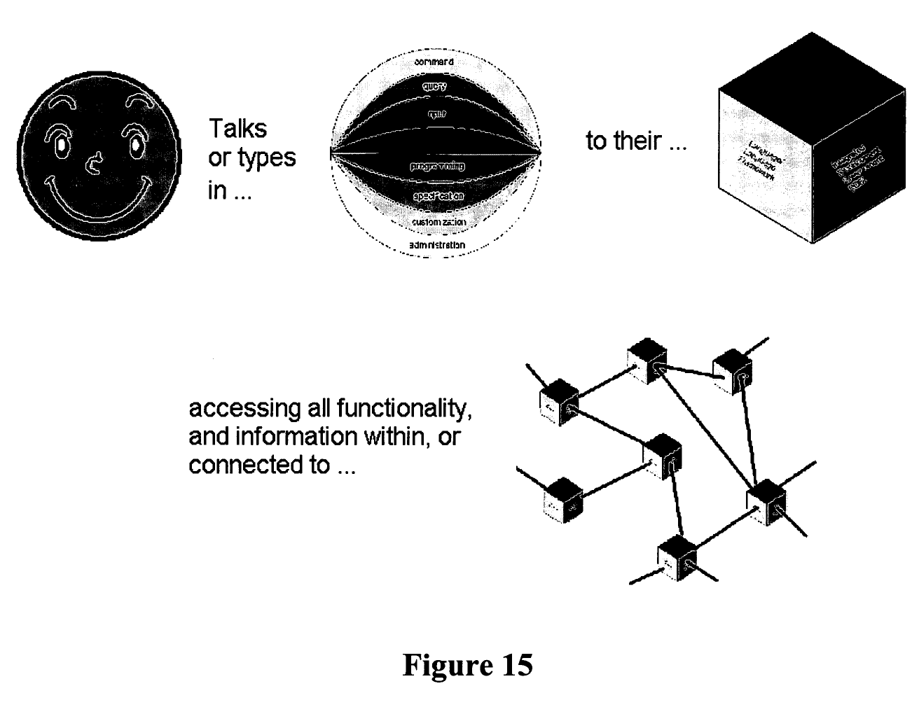

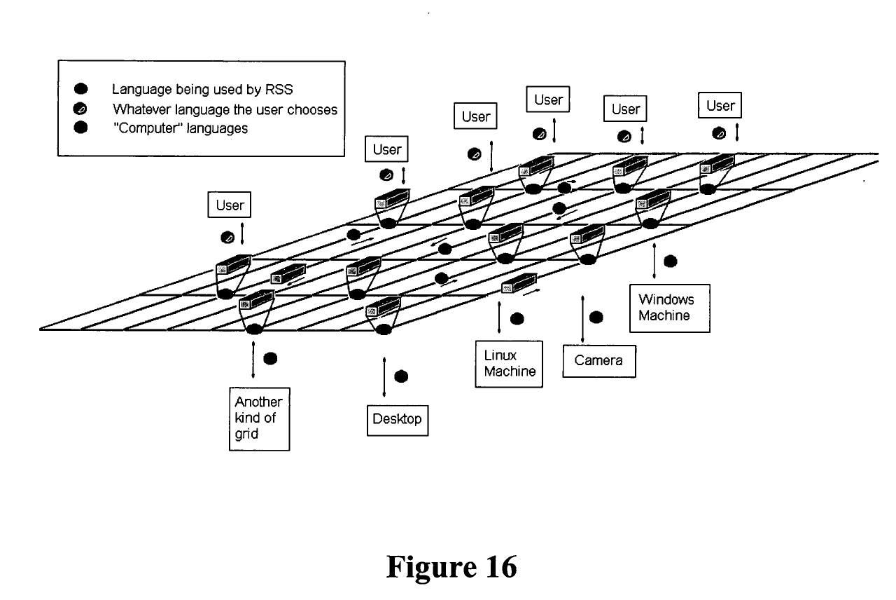

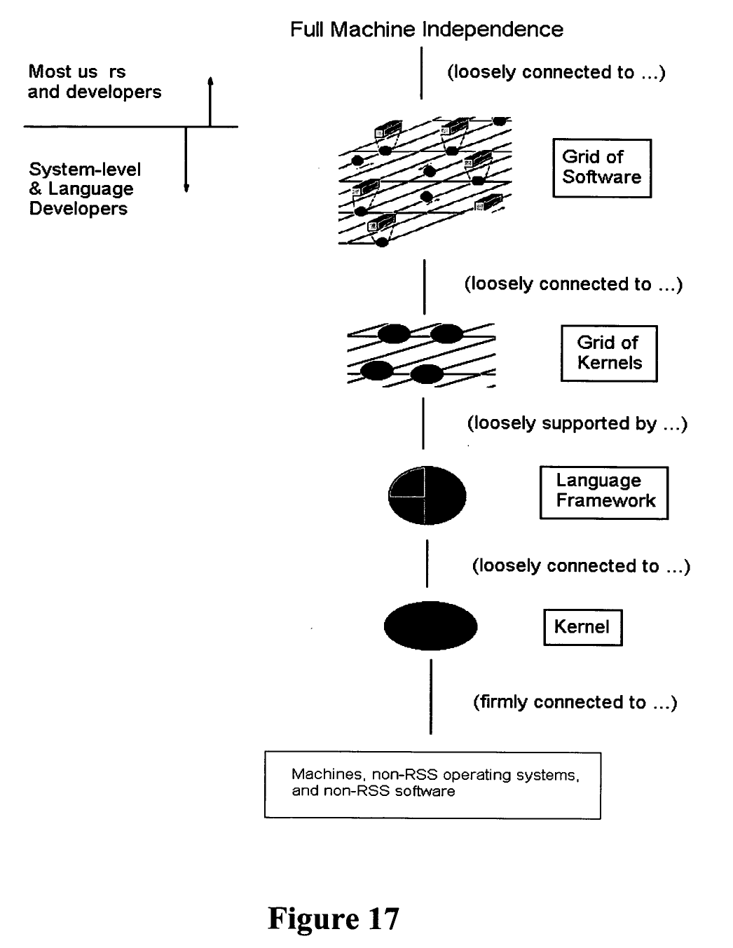

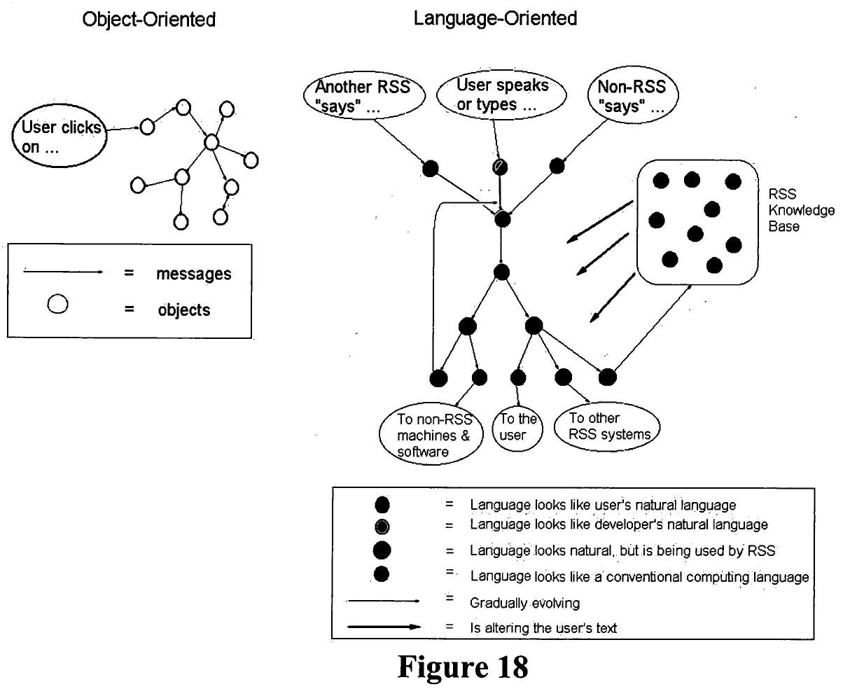

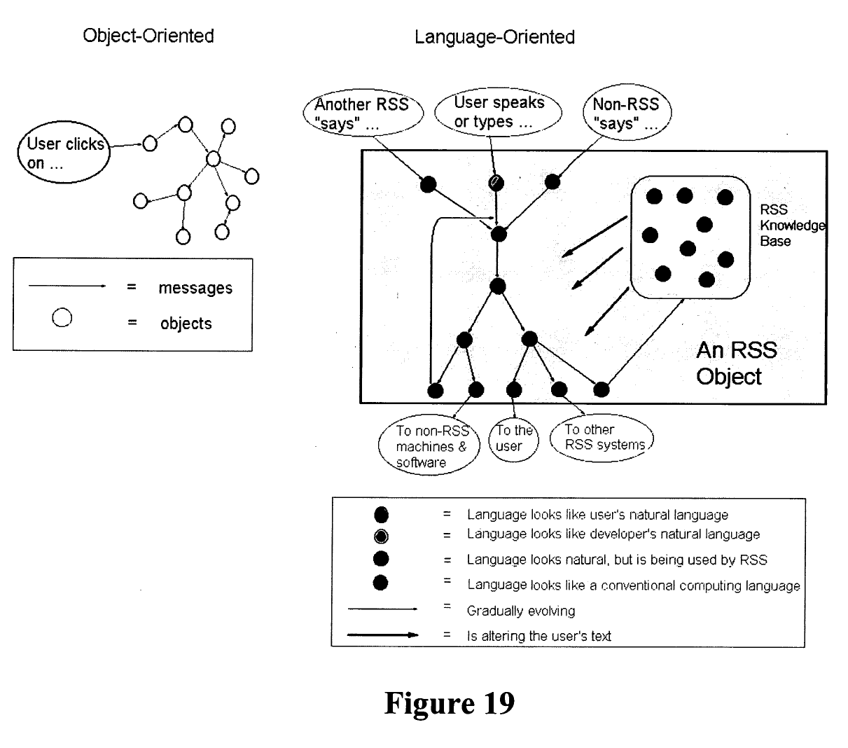

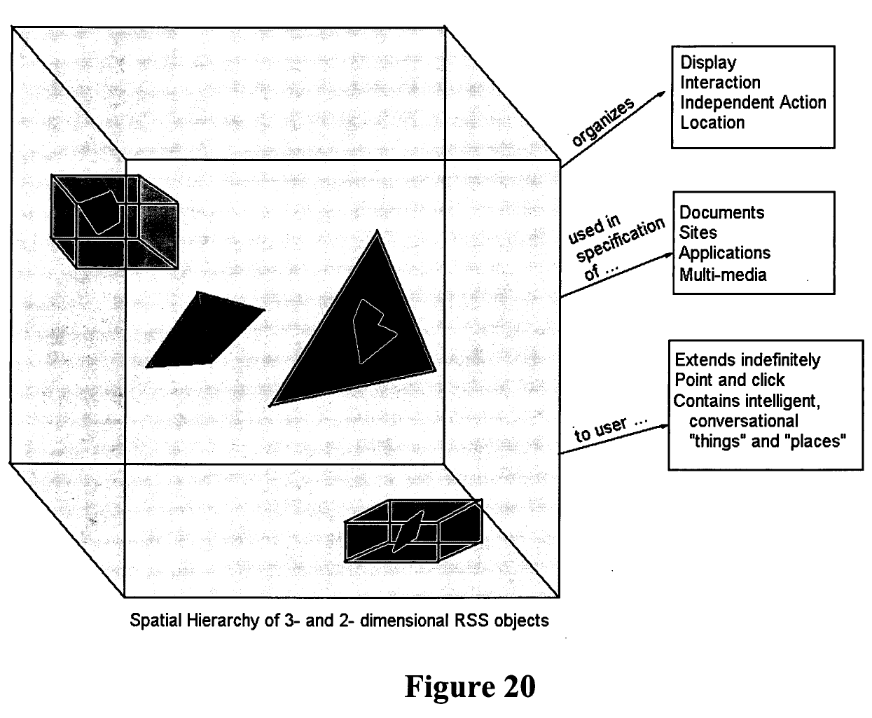

FIGS. 4-20 provide a general overview and various aspects of the present invention. The language framework, grid computing, kernel merging and other aspects of the present invention are obvious from the Figures.

By applying language processing to the present invention, new uses for the present invention can be readily created by creating fairly simple computer programs. These new programs effectively provide a real-time synthesis of internal and external resources. Essentially, language processing provides a language-driven approach to software integration. Usually, this is in response to the user, but can also be used by the “objects”.

The language growth can encompass any type of natural language (French, for example), or any formally definable language (C, XML, a proprietary interface language, etc.). The quality of the language available to any user is a function of the quality of the combinations of languages and combinations of language processing available on the grid, not just their system.

Grid computing, as used herein, is intended to refer to a whole host of different ideas: X Internet, Web Services, Microsoft Corporation's “.Net” architecture, peer-to-peer networks, ubiquitous computing, and the like. The present invention can use language-processing at the core of the “grid” with objects of the present invention as the graphical aspect to the grid, and also the overarching organizational component (for autonomous action, etc.).

Another aspect of the present invention is dataflow. Dataflow is preferably used to understand the user, refining such understandings, code creation, translation into computer languages, translation between human languages, and in the decision-making process when delegating tasks across machine or system boundaries. The identities or concept representatives are the vocabulary and data flow acts as the grammar. In addition, all communication between objects is done via dataflow connections.

The drill down technique of the present invention is preferably used during viewing and moving of “objects”. It can be used to organize places as well as virtual “things.”

The present invention also improves and provides for kernel merging. Kernels can cooperate in the refining (processing) of language trees and they take care of objects which simultaneously sit on two machines. Additionally, kernels keep track of converting local identities into universal IDs and vice versa.

Language trees consist of nodes which refer to identities. Between any two nodes are two “pipelines” in which data (conceptually) flows. Each pipeline is one way. At each end of each pipeline is a “description”. On the sending side, there is a description of what is going to be sent and on the receiving side a description of what can be received. To be valid, these two descriptions must at least be potentially compatible. The data to be “flowed” can be identities, trees of identities, or groups of identities. Sometimes, it may be the same identity as found in the node on the sending side but more often, it will be another identity.

There is an implied order to the flow of data. A node preferably receives data from above. It sends data to its first child, then receives data from the first child, then sends data to its second, and so on. Finally, upon receiving data from its last child, it returns data upward. However, this order can be bypassed through kernel-level instructions.

The dataflow descriptions are generally established early in the refinement process, usually as part of the matching of user text. During the matching process, logics are invited to understand the text. Some logics embed identities into the embryonic tree; other logics embed dataflow descriptions. In general, these flows are not “implementable” at this point in refinement. Instead, they are purely conceptual and are used to precisely describe what a particular sentence, or phrase, or idea, is doing. One purpose of refinement is to alter the tree until the data can actually flow.

As an example, looking just at the identity “dog” within a language tree, the identity refers to the idea of dog and can be used in many ways. By way of example, a language tree can be built for the phrase “Spot is a dog”, because the present invention can define the identity “is” to have two children, and the tree can be created with “Spot” on the left and “dog” on the right. Dog receives a “thing”, and returns upward nothing. Ultimately, when the data actually flows, dog will receive Spot, but right after matching, the only thing it is telling dog is that some “thing” will flow downward. Dog is expecting a “thing” so the tree is sound. This use of “dog” corresponds to a description that can be assigned to things.

If the language processing unit is asked “is spot a dog?”, the object “dog” receives anything, and returns a conditional. Essentially, this use of dog is as a test. Note, that dog can receive anything (red, baseball, time etc.).

If the language processing unit is asked “Can a cat be a dog?”, dog receives a description, and returns a possibility.

If the language processing unit is asked to list all dogs, dog receives nothing, and returns upward a “group”. This group has its own data flow, which receives a number, and returns upward a single dog.

If the language processing unit is asked “Can dogs drive?”, dog is receiving nothing and returning to “drive” itself. Drive then returns upward a possibility.

If the language processing unit is asked “What is a dog?”, dog may receive nothing, and return a description (not itself).

If the language processor is told “Spot is a dog from California”, dog receives a thing as in the first example, but it is also sending a “thing” down to the “from” object. From is receiving a “place” from California.

Because all of these descriptions are themselves trees, they can be as expressive as need be. The only rule of these “description” trees is that they accept a candidate, and return a value ranging from “is” to “is not”, or, these trees accept another description, and return a value ranging from “fully encompasses” to “no overlap”. The former would test a specific candidate, whereas the latter would be used to test the overall viability of a particular dataflow pipeline The tree referred to above in paragraph 64 is an example of a very primitive description tree. As trees refine they gradually get more expressive. For example, as the last example “from” is going to want to set stricter requirements on its lower branch, and “California” will have to provide a more precise description of itself, in response. By way of example, “Spot is a dog from the moon” would pass early matching, but later refinement would flag the fact that that dogs cannot really be from the moon because the requirements of “from” would gradually expand and the moon could not keep up with those changes. As all of these checks are made they are reflected in continually more expressive requirements & descriptions.

Notice that entire ideas can be used in different ways such as: the “drive” identity in “John is driving to the store” as compared to “did John drive to the store” where it is returning a conditional. In the phrase “It is probably true that John drove to the store” it is receiving a probability and returning nothing. “What is “John drove to the store?” in French”, it is returning French text.

Dataflow is a mechanism for expressing language like people do. People have a natural ability to use words in different ways in accordance with context. Data flow is essentially providing a mechanism to describe exactly how a particular concept is being used at a particular time. It is used in a multitude of ways within both individual systems and across clusters. It provides a consistent framework for all communication, at all levels, ranging from the highest level (user to computer), the development level, between systems, between objects, during the refinement process, and during the actual execution of logic. It is designed to consistently mirror human language, so that people can more readily and easily understand the inner working of their system. People have an innate ability to be extremely expressive, even with a limited language. One principle reason for this is that a subtle flow of information combines with vocabulary that exponentially increases the expressive power. Similarly, because this mechanism is used for all inter- and intra-system communication, and because this mechanism does not need a massive vocabulary to be highly expressive, individual systems and clusters of systems can grow, without falling into the trap of having large numbers of overlapping communication protocols, and without having large numbers of competing vocabularies.

While the invention has been described in detail and with reference to specific embodiments thereof, it will be apparent to those skilled in the art that various changes and modifications can be made therein without departing from the spirit and scope thereof.

We claim as our invention:

1. A method of determining the spatial location of an object in question within a containing space, comprising:
defining a containing space;
identifying an object in question within the containing space;
dividing the containing space into a plurality of parent spaces; and,
for each of the parent spaces, iteratively repeating a query process, comprising:
i) querying the parent space to determine if the object in question is within the parent space;
ii) if the object in question is completely within or completely outside the parent space, returning the result to the containing space; and
iii) if the object in question is partially within the parent space, subdividing the parent space into a plurality of child spaces, and iteratively repeating the query process for each of the child spaces, wherein each child space is treated as a parent space.

2. The method of claim 1, wherein the step of querying the parent space to determine if the object in question is within the parent space further comprises defining a sphere around the object in question and determining if the sphere is within the parent space.

3. The method of claim 1, wherein the step of querying the parent space to determine if the object in question is within the parent space further comprises defining a circle around the object in question and determining if the sphere is within the parent space.

4. A method of determining the spatial location of an object in question within a containing space, comprising:
defining a containing space;
identifying an object in question within the containing space;
dividing the containing space into a plurality of parent spaces; and,
for each of the parent spaces, iteratively repeating a query process, comprising:
i) querying the parent space to determine if the parent space is within the object question;
ii) if the parent space is completely within or completely outside the object in question, returning the result to the containing space; and
iii) if the parent space is partially within the object in question, subdividing the parent space into a plurality of child spaces, and iteratively repeating the query process for each of the child spaces, wherein each child space is treated as a parent space.

5. The method of claim 1, wherein the step of querying the parent space to determine if the parent space is within the object in question further comprises defining a sphere around the object in question and determining if the parent space is within the sphere.

6. The method of claim 1, wherein the step of querying the parent space to determine if the parent space is within the object in question further comprises defining a circle around the object in question and determining if the parent space is within the sphere.

7. A method of determining the spatial location of an object in question within a containing space, comprising:
defining a containing space;
identifying an object in question within the containing space;
dividing the containing space into a plurality of parent spaces; and,
for each of the parent spaces, iteratively repeating a query process, comprising:
i) querying the object in question to determine if the parent space is within the object question;
ii) if the parent space is completely within or completely outside the object in question, returning the result to the containing space; and
iii) if the parent space is partially within the object in question, subdividing the parent space into a plurality of child spaces, and iteratively repeating the query process for each of the child spaces, wherein each child space is treated as a parent space.

8. The method of claim 1, wherein the step of querying the object in question to determine if the parent space is within the object in question further comprises defining a sphere around the object in question and determining if the parent space is within the sphere.

9. The method of claim 1, wherein the step of querying the parent space to determine if the parent space is within the object in question further comprises defining a circle around the object in question and determining if the parent space is within the sphere.
